(19) United States
(12) Patent Application Publication
(10) Pub. No.: US 2025/0210269 A1
(43) Pub. Date: Jun. 26, 2025

(54) CAPACITOR

(71) Applicant: SAMSUNG ELECTRO-MECHANICS CO., LTD., Suwon-si (KR)

(72) Inventors: Sung-Min Cho, Suwon-si (KR); Moonchul Lee, Suwon-si (KR); Sehun Park, Suwon-si (KR); Taejoon Park, Suwon-si (KR); Seung-Hun Han, Suwon-si (KR)

(73) Assignee: SAMSUNG ELECTRO-MECHANICS CO., LTD., Suwon-si (KR)

(21) Appl. No.: 18/737,478

(22) Filed: Jun. 7, 2024

(30) Foreign Application Priority Data
Dec. 21, 2023 (KR) 10-2023-0188780

(51) Int. Cl. H01G 4/232; H01G 4/30

(52) U.S. Cl. CPC H01G 4/232; H01G 4/30

(57) ABSTRACT

A capacitor according to an aspect of an embodiment includes: a body that includes a first internal electrode and a second internal electrode stacked with a dielectric layer interposed therebetween; a first external electrode that is disposed to cover an upper surface of the body and an outer side surface of the body and is connected to the first internal electrode through the upper surface of the body and the outer side surface of the body; and a second external electrode that is disposed to cover the upper surface of the body and the outer side surface of the body and is connected to the second internal electrode through the upper surface of the body and the outer side surface of the body.

### CROSS-REFERENCE TO RELATED APPLICATION

This application claims priority to and the benefit of Korean Patent Application No. 10-2023-0188780 filed at the Korean Intellectual Property Office on Dec. 21, 2023, the entire contents of which are incorporated herein by reference.

### TECHNICAL FIELD

The present disclosure relates to a capacitor.

### BACKGROUND

An electronic component used in an electronic device includes a capacitor, an inductor, a piezoelectric element, a varistor, a thermistor, or the like. A stacked capacitor among a ceramic electronic component may be used in various electronic devices due to a small size, a high capacity, and easy mounting thereof. For example, the stacked capacitor may be used in a chip-type condenser that is installed at substrates of various electronic products such as an image device (e.g., a liquid crystal displays (LCD), a plasma display panel (PDP), an organic light-emitting diode (OLED), or the like), a computer, a personal portable terminal, a smartphone, and the like to play a role in charging or discharging electricity.

With a recent trend of down-sizing and thinning of the electronic product, a demand for a capacitor with higher capacity and smaller equivalent serial resistance (ESR) than those of a conventional stacked capacitor is increasing.

### SUMMARY

According to at least one embodiment among embodiments of the present disclosure, a capacitor having a small equivalent serial resistance (ESR) without capacity loss may be provided.

A capacitor according to an aspect of the present disclosure includes: a body that includes a first internal electrode and a second internal electrode stacked with a dielectric layer interposed therebetween; a first external electrode that is disposed to cover an upper surface of the body and an outer side surface of the body and is connected to the first internal electrode through the upper surface of the body and the outer side surface of the body; and a second external electrode that is disposed to cover the upper surface of the body and the outer side surface of the body and is connected to the second internal electrode through the upper surface of the body and the outer side surface of the body

The capacitor may further include: a first connection via disposed inside the body to connect the first internal electrode and the first external electrode; and a second connection via disposed inside the body to connect the second internal electrode and the second external electrode.

The capacitor may further include a first via separation layer disposed between the first connection via and the second internal electrode.

The capacitor may further include a second via separation layer disposed between the second connection via and the first internal electrode.

The first external electrode may contact the first connection via, and the second external electrode may contact the second connection via.

The capacitor may further include: a first connection layer connecting the first external electrode and the first connection via; and a second connection layer connecting the second external electrode and the second connection via.

The first connection layer and the second connection layer may be disposed on an uppermost dielectric layer among dielectric layers including the uppermost dielectric layer.

The number of first connection vias including the first connection via may be greater than or equal to the number of first external electrodes including the first external electrode.

The number of second connection vias including the second connection via may be greater than or equal to the number of second external electrodes including the second external electrode.

Each of the first external electrode and the second external electrode may be disposed adjacent to a corner where an end portion of the body in a length direction and an end portion of the body in a width direction meet.

Each of the first external electrode and the second external electrode may be provided in two.

The first external electrode may be connected to a portion of the first internal electrode exposed to the outer side surface of the body, and the second external electrode may be connected to a portion of the second internal electrode exposed to the outer side surface of the body.

The capacitor may further include: a first electrode separation layer disposed between the first external electrode and the second internal electrode; and a second electrode separation layer disposed between the second external electrode and the first internal electrode.

A capacitor according to another aspect of an embodiment includes: a substrate; a body that includes a first internal electrode and a second internal electrode stacked with a dielectric layer interposed therebetween and is disposed on the substrate; a first external electrode that is disposed to cover an upper surface of the body and an outer side surface of the body and is connected to the first internal electrode; and a second external electrode that is disposed to cover the upper surface of the body and the outer side surface of the body and is connected to the second internal electrode.

The first external electrode may be connected to the first internal electrode exposed to the outer side surface of the body, and the second external electrode may be connected to the second internal electrode exposed to the outer side surface of the body.

Each of the first external electrode and the second external electrode may be disposed adjacent to a corner where an end portion of the body in a length direction and an end portion of the body in a width direction meet.

Each of the first external electrode and the second external electrode may be provided in two.

A capacitor according to another aspect of an embodiment includes: a substrate; a body that includes a first internal electrode and a second internal electrode stacked with a dielectric layer interposed therebetween and is disposed on an upper surface of the substrate; two first external electrodes that are disposed to be spaced apart from each other on an upper surface of the body and are connected to the first internal electrode; and two second external electrodes that are disposed to be spaced apart from each other on the upper surface of the body and are connected to the second internal electrode.

The capacitor may further include: a first connection via disposed inside the body and connected to the first internal electrode; and a second connection via disposed inside the body and connected to the second internal electrode.

A portion of the first external electrodes may cover an outer side surface of the body and may be connected to a portion of the first internal electrode exposed to the outer side surface of the body, and a portion of the second external electrodes may cover the outer side surface of the body and may be connected to a portion of the second internal electrode exposed to the outer side surface of the body.

According to the at least one embodiment among the embodiments, a capacitor having a small equivalent serial resistance (ESR) without capacity loss may be provided.

### BRIEF DESCRIPTION OF THE DRAWINGS

FIG. 1 is a view showing a capacitor according to an embodiment of the present disclosure.

FIG. 2 is a longitudinal cross-sectional view taken along a line A-A′ of FIG. 1.

FIG. 3 is a view showing a state in which the capacitor is mounted on a mounting substrate according to an embodiment of the present disclosure.

FIGS. 4, 5, 6, 7, 8, 9, 10, and 11 are views showing a method for manufacturing the capacitor according to an embodiment of the present disclosure.

FIG. 12 is a plan view of a capacitor according to a second embodiment.

FIG. 13 is a cross-sectional view of a capacitor according to a third embodiment.

FIG. 14 is a view showing a capacitor according to a fourth embodiment.

FIG. 15 is a cross-sectional view taken along a line B-B′ of FIG. 14.

FIGS. 16, 17, 18, 19, and 20 are views showing a method for manufacturing the capacitor of the fourth embodiment according to an embodiment of the present disclosure.

FIG. 21 is a view showing a capacitor according to a fifth embodiment.

FIG. 22 is a cross-sectional view taken along a line C-C′ of FIG. 21.

FIG. 23 is a cross-sectional view taken along a line D-D′ of FIG. 22.

FIG. 24 is a plan view of a capacitor according to a sixth embodiment.

FIG. 25 is a plan view of a capacitor according to a seventh embodiment.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In order to clearly describe the present disclosure, parts or portions that are irrelevant to the description are omitted, and identical or similar constituent elements throughout the specification are denoted by the same reference numerals.

Further, in the drawings, the size and thickness of each element are arbitrarily illustrated for ease of description, and the present disclosure is not necessarily limited to those illustrated in the drawings. In the drawings, the thicknesses of layers, films, panels, regions, areas, etc., are exaggerated for clarity. In the drawings, for ease of description, the thicknesses of some layers and areas are exaggerated.

It will be understood that when an element such as a layer, film, region, area, or substrate is referred to as being “on” or “above” another element, it may be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

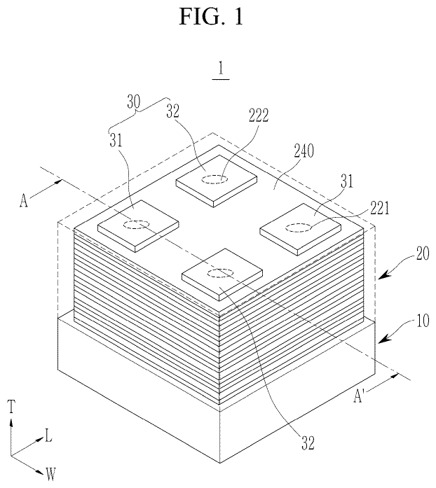

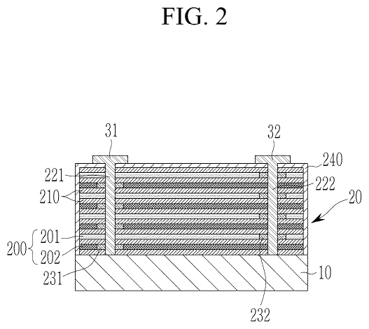

FIG. 1 is a view showing a capacitor 1 according to an embodiment of the present disclosure, and FIG. 2 is a longitudinal cross-sectional view taken along a line A-A′ of FIG. 1.

Referring to FIG. 1 and FIG. 2, the capacitor 1 according to the embodiment may include a substrate 10, a body 20, and an external electrode 30.

The substrate 10 has a predetermined area. The substrate 10 may be provided as an insulating material. As an example, the substrate 10 may be a silicon substrate or the like. The substrate 10 may have upper and lower surfaces facing each other. The substrate 10 has a predetermined thickness in a vertical direction (or a top and bottom direction) T where the upper and lower surfaces are spaced apart.

The substrate 10 may have a predetermined width in a width direction W crossing the vertical direction T. The width direction W may be orthogonal to the vertical direction T. The substrate 10 may have a predetermined length along a length direction L crossing the top and bottom direction (T) and the width direction W. The length direction L may be orthogonal to the vertical direction T and the width direction W. A length of the substrate 10 may be larger than a width of the substrate 10.

The body 20 may be disposed on an upper surface of the substrate 10. The body 20 includes internal electrodes 200 and dielectric layers 210. The body 20 may have a predetermined length along the length direction L of the substrate 10. The body 20 may have a predetermined width along the width direction W of the substrate 10. The body 20 may have a predetermined thickness along the vertical direction T.

The internal electrodes 200 are stacked and disposed on the upper surface of the substrate 10. The internal electrodes 200 are provided as a conductive material. The internal electrodes 200 may be made of a metallic material. The internal electrodes 200 may be stacked in the vertical direction T. The dielectric layer 210 may be disposed between internal electrodes 200 adjacent to each other in the vertical direction T. Additionally, the dielectric layer 210 may be disposed on the internal electrode 200 disposed at an uppermost side. The dielectric layer 210 may be formed of any one of metal oxides such as Al₂O₃ ZrO₂, HfO₂, AlN, and the like. Additionally, the dielectric layer 210 may be formed of a combination of metal oxides such as Al₂O₃ ZrO₂, HfO₂, AlN, and the like. Additionally, the dielectric layer 210 may be formed of ZAZ that is a ZrO₂-Al₂O₃-ZrO₂ composite layer.

The internal electrodes 200 may include a first internal electrode 201 and a second internal electrode 202.

The first internal electrode 201 and the second internal electrode 202 may be stacked and disposed on the upper surface of the substrate 10. The first internal electrode 201 and the second internal electrode 202 may be alternately stacked. The dielectric layer 210 may be disposed between the first internal electrode 201 and the second internal electrode 202. The first internal electrode 201 and the second internal electrode 202 may be provided as a conductive material. The first internal electrode 201 and the second internal electrode 202 may be provided as a non-magnetic material. The first internal electrode 201 may be made of a metallic material. The second internal electrode 202 may be made of a metallic material. The first internal electrode 201 and the second internal electrode 202 may be made of different materials. Accordingly, the first internal electrode 201 and the second internal electrode 202 may be selectively etched. For example, the first internal electrode 201 may include molybdenum, and the second internal electrode 202 may include titanium.

The external electrode 30 may be connected to the internal electrodes 200 of the body 20. The external electrode 30 may be disposed to cover a portion of an outer side surface of the body 20. The external electrode 30 may be disposed on an upper surface of the body 20. The external electrode 30 may be connected to the internal electrodes 200 through connection vias 221 and 222.

The connection vias 221 and 222 may be disposed inside the body 20. The connection vias 221 and 222 may be electrically connected to the internal electrodes 200. The connection vias 221 and 222 may extend toward a direction in which the internal electrodes 200 are spaced apart from each other. As an example, the connection vias 221 and 222 may extend in the vertical direction T.

The connection vias 221 and 222 may penetrate a region where the internal electrode 200 is disposed in the body 20. Lower portions of the connection vias 221 and 222 may be disposed adjacent to a bottom surface of the body 20. As an example, the lower portions of the connection vias 221 and 222 may contact the upper surface of the substrate 10. Upper portions of the connection vias 221 and 222 may be disposed adjacent to the upper surface of the body 20. As an example, the upper portions of the connection vias 221 and 222 may be exposed on the upper surface of the body 20. In this case, the upper portions of the connection vias 221 and 222 may be coplanar with the upper surface of the body 20. Additionally, the upper portions of the connection vias 221 and 222 may protrude upward from the upper surface of the body 20. The upper portions of the connection vias 221 and 222 may be connected directly to the external electrode 30.

The connection vias 221 and 222 may include a first connection via 221 and a second connection via 222.

The first connection via 221 may be electrically connected to the first internal electrode 201. The first connection via 221 may penetrate the region where the internal electrode 200 is disposed in the body 20, and the first connection via 221 may be connected to the first internal electrode 201 by contacting the first internal electrode 201. The first connection via 221 may be electrically separated from the second internal electrode 202. That is, a first via separation layer 231 may be disposed between the first connection via 221 and the second internal electrode 202. The first via separation layer 231 may have a ring structure to surround the first connection via 221. That is, the second internal electrode 202 may be spaced apart from the first connection via 221 at a region adjacent to the first connection via 221. Additionally, the first via separation layer 231 may be disposed to be filled between the first connection via 221 and the second internal electrode 202. The first via separation layer 231 may be provided as an insulating material. As an example, the first via separation layer 231 may be provided as alumina (Al₂O₃), silicon oxide, or the like. The dielectric layer 210 may be disposed at both sides of the first via separation layer 231 in the vertical direction T.

The second connection via 222 may be electrically connected to the second internal electrode 202. The second connection via 222 may penetrate the region where the internal electrode 200 is disposed in the body 20, and the second connection via 222 may be connected to the second internal electrode 202 by contacting the second internal electrode 202. The second connection via 222 may be electrically separated from the first internal electrode 201. That is, a second via separation layer 232 may be disposed between the second connection via 222 and the first internal electrode 201. The second via separation layer 232 may have a ring structure to surround the second connection via 222. That is, the first internal electrode 201 may be spaced apart from the second connection via 222 at a region adjacent to the second connection via 222. Additionally, the second via separation layer 232 may be disposed to be filled between the second connection via 222 and the first internal electrode 201. The second via separation layer 232 may be provided as an insulating material. As an example, the second via separation layer 232 may be provided as alumina (Al₂O₃), silicon oxide, or the like. The dielectric layer 210 may be disposed at both sides of the second via separation layer 232 in the vertical direction T.

An insulating layer 240 may be disposed on an outer side surface of the body 20. That is, the insulating layer 240 may be disposed outside an end portion of the first internal electrode 201 and an end portion of the second internal electrode 202 in the length direction L and the width direction W of the body 20, so that the first internal electrode 201 and the second internal electrode 202 are insulated from the outside. Additionally, the insulating layer 240 may be disposed on the upper surface of the body 20. In this case, the connection vias 221 and 222 may penetrate the insulating layer 240 to be connected to the external electrode 30. The insulating layer 240 may be provided as alumina (Al₂O₃), silicon oxide, or the like.

The external electrode 30 may include a first external electrode 31 and a second external electrode 32.

The first external electrode 31 may be disposed on the upper surface of the body 20. The first external electrode 31 may be disposed on an upper surface of an end portion of the body 20 in the length direction L. The first external electrode 31 is connected to the first internal electrode 201. The first external electrode 31 may be connected to the first internal electrode 201 through the first connection via 221. The first connection via 221 may be disposed at a lower region of the first external electrode 31 in the vertical direction T, so that an upper portion of the first connection via 221 is connected to and contacts the first external electrode 31. The first external electrode 31 may be provided in a plural number. As an example, two first external electrodes 31 may be provided. In addition, two first connection vias 221 may be provided, and each first connection via 221 may be disposed at the lower region of the first external electrode 31 in the vertical direction T. The two first external electrodes 31 may be disposed on upper surfaces of both ends of the body 20 in the length direction L, respectively. Accordingly, the two first external electrodes 31 may be disposed to be spaced apart from each other along the length direction L of the body 20. Additionally, the two first external electrodes 31 may be disposed to be spaced apart from each other along the width direction W of the body 20. Accordingly, the two first external electrodes 31 may be disposed to be spaced apart from each other in a diagonal direction crossing the length direction L and the width direction W of the body 20. The first external electrode 31 may be disposed adjacent to a corner where an end portion of the body 20 in the length direction L and an end portion of the body 20 in the width direction W meet.

The second external electrode 32 is disposed on the upper surface of the body 20. The second external electrode 32 may be disposed on an upper surface of an end portion of the body 20 in the length direction L. The second external electrode 32 is connected to the second internal electrode 202. The second external electrode 32 may be connected to the second internal electrode 202 through the second connection via 222. The second connection via 222 may be disposed at a lower region of the second external electrode 32 in the vertical direction T, so that an upper portion of the second connection via 222 is connected to and contacts the second external electrode 32. The second external electrode 32 may be provided in a plural number. As an example, two second external electrodes 32 may be provided. In addition, two second connection vias 222 may be provided, and each second connection via 222 may be disposed at the lower region of the second external electrode 32 in the vertical direction T. Two second external electrodes 32 may be disposed on the upper surface of both ends of the body 20 in the length direction L, respectively. Accordingly, the two second external electrodes 32 may be disposed to be spaced apart from each other along the length direction L of the body 20. Additionally, the two second external electrodes 32 may be disposed to be spaced apart from each other along the width direction W of the body 20. Accordingly, the two second external electrodes 32 may be disposed to be spaced apart from each other in a diagonal direction crossing the length direction L and the width direction W of the body 20. The two second external electrodes 32 may be disposed to be spaced apart from the two first external electrodes 31 in the width direction W of the body 20, respectively. The second external electrode 32 may be disposed adjacent to a corner where an end portion of the body 20 in the length direction L and an end portion of the body 20 in the width direction W meet.

In one embodiment, the first and second connection vias 221 and 222 may overlap the first and second external electrodes 31 and 32, respectively, in the vertical direction T.

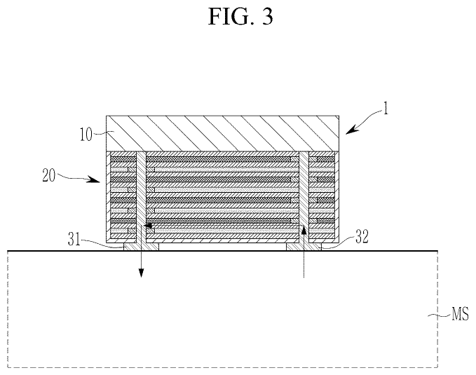

FIG. 3 is a view showing a state in which the capacitor 1 is mounted on a mounting substrate MS according to an embodiment of the present disclosure.

Referring to FIG. 3, a current path occurs between the mounting substrate MS and the capacitor 1 if the capacitor 1 according to an embodiment of the present disclosure is used in the state in which the capacitor 1 is mounted on the mounting substrate MS. In this case, the current path occurs in a form of connecting the first external electrode 31 and the second external electrode 32. The insulating layer 240 disposed at a region of the upper surface of the body 20 may be provided in a form of a thin film. For example, a thickness of the insulating layer 240 disposed at the region of the upper surface of the body 20 may be 2 μm or less. Accordingly, the current path may be shortened in the vertical direction T, so that an equivalent serial resistance (ESR) is reduced. Additionally, the current path is formed between the first connection via 221 and the second connection via 222 inside the body 20. Accordingly, the current path is shortened compared with an entire length of the body 20, so that the equivalent serial resistance (ESR) is reduced. In addition, because the first external electrode 31 and the second external electrode 32 are provided in a plural number, a region where the current path is formed inside the body 20 may be adjusted to reduce the equivalent serial resistance (ESR).

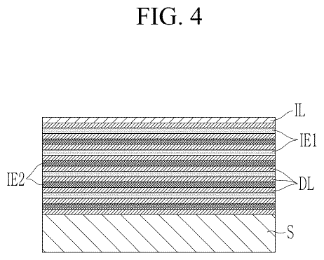

FIGS. 4 to 11 are views showing a method for manufacturing the capacitor according to an embodiment of the present disclosure.

Hereinafter, the method for manufacturing the capacitor 1 according to the embodiment will be described with reference to FIGS. 4 to 11.

Referring to FIG. 4, internal electrode layers IE1 and IE2 and a dielectric layer DL for forming the body 20 are formed on a substrate S. The substrate S may be a silicon substrate or the like. The substrate S may be provided with an area larger than that of two bodies 20. Additionally, an area of a region where the internal electrode layers IE1 and IE2 and the dielectric layer DL are formed may be larger than an area occupied by one body 20. For convenience of illustration, FIG. 4 shows a region where one body 20 is formed on the substrate S.

The internal electrode layers IE1 and IE2 and the dielectric layer DL may be alternately formed. In the internal electrode layers IE1 and IE2 and the dielectric layer DL for forming the body 20, the dielectric layer DL may be lastly formed. Accordingly, the dielectric layer DL may be disposed on the internal electrode layers IE1 and IE2 disposed at an uppermost side.

The internal electrode layers IE1 and IE2 and the dielectric layer DL may be formed through a deposition process. Chemical vapor deposition (CVD), atomic layer deposition (ALD), sputtering, or the like may be used to form the internal electrode layers IE1 and IE2. Chemical vapor deposition (CVD), atomic layer deposition (ALD), sputtering, or the like may be used to form the dielectric layer DL.

The internal electrode layers IE1 and IE2 may include the first internal electrode layer IE1 and the second internal electrode layer IE2. The first internal electrode layer IE1 and the second internal electrode layer IE2 may be alternately formed. Different materials may be used for forming the first internal electrode layer IE1 and the second internal electrode layer IE2. For example, the first internal electrode layer IE1 may be formed using molybdenum, and the second internal electrode layer IE2 may be formed using titanium.

Additionally, an insulating layer IL may be formed at an uppermost portion thereof. The insulating layer IL may be formed through a deposition process. Chemical vapor deposition (CVD), atomic layer deposition (ALD), sputtering, or the like may be used to form the insulating layer IL.

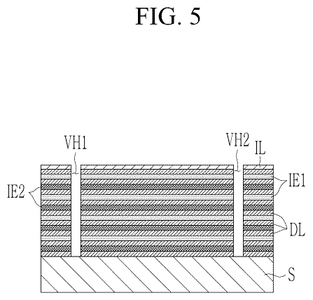

Referring to FIG. 5, via holes VH1 and VH2 are formed by penetrating the internal electrode layers IE1 and IE2, the dielectric layer DL, and the insulating layer IL. As an example, the via holes VH1 and VH2 may be formed through an etching process. The etching process may be performed by dry etching using plasma. Additionally, the via holes VH1 and VH2 may be formed through a hole processing using a laser. The via holes VH1 and VH2 may include the first via hole VH1 and the second via hole VH2. The first via hole VH1 may be formed in a plural number and the first via holes VH1 may be spaced apart from each other. As an example, two first via holes VH1 may be formed. The second via hole VH2 may be formed in a plural number and the second via holes VH2 may be spaced apart from each other. As an example, two second via holes VH2 may be formed.

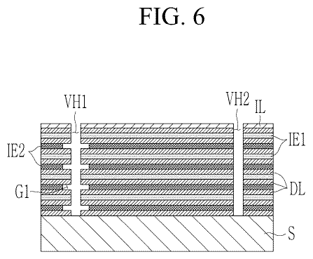

Referring to FIG. 6, a first groove G1 may be formed at an inner region of the first via hole VH1. The first groove G1 may be formed by etching the second electrode layer IE2 exposed toward the first via hole VH1. The first groove G1 may be formed through dry etching using a chemical or dry etching using plasma. While the etching is performed at the inner region of the first via hole VH1, the second via hole VH2 may be obscured using a mask. The mask may be formed through a photolithography process so that a region where the first via hole VH1 is disposed is opened and a region where the second via hole VH2 is disposed is obscured.

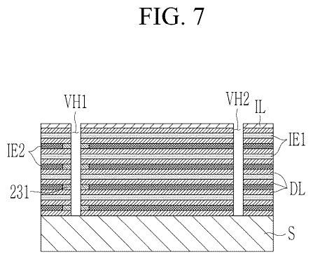

Referring to FIG. 7, the first via separation layer 231 may be formed in the first groove G1. As an example, the first via separation layer 231 may be formed by a method in which an insulating material is filled inside the first via hole VH1 and the insulating material is etched again in a region other than the first groove G1.

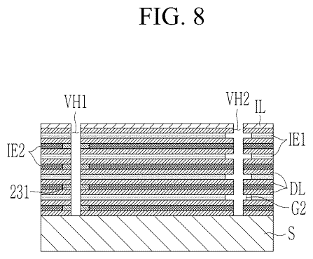

Referring to FIG. 8, a second groove G2 may be formed at an inner region of the second via hole VH2. The second groove G2 may be formed by etching the first electrode layer IE1 exposed toward the second via hole VH2.

The second groove G2 may be formed through dry etching using a chemical or dry etching using plasma.

While the etching is performed at the inner region of the second via hole VH2, the first via hole VH1 may be obscured using a mask. The mask may be formed through a photolithography process so that a region where the second via hole VH2 is disposed is opened and a region where the first via hole VH1 is disposed is obscured.

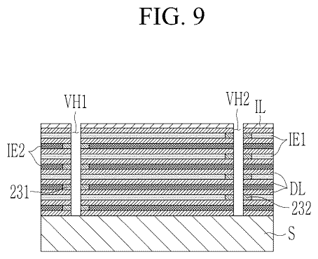

Referring to FIG. 9, the second via separation layer 232 may be formed in the second groove G2. As an example, the second via separation layer 232 may be formed by a method in which an insulating material is filled inside the second via hole VH2 and the insulating material is etched again in a region other than the second groove G2.

FIGS. 6 to 9 illustrate a case where the second via separation layer 232 is formed after the first via separation layer 231 is formed, but the first via separation layer 231 may be formed after the second via separation layer 232 is formed.

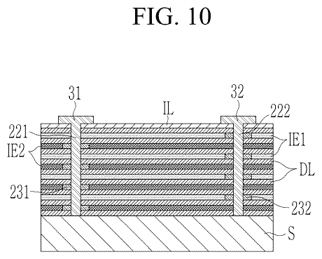

Referring to FIG. 10, the first connection via 221 may be formed in the first via hole VH1, and the second connection via 222 may be formed in the second via hole VH2. The first connection via 221 and the second connection via 222 may be formed through a deposition process. Chemical vapor deposition (CVD), atomic layer deposition (ALD), sputtering, or the like may be used to form the first connection via 221 and the second connection via 222. Additionally, the first connection via 221 and the second connection via 222 may be formed by a plating process.

Thereafter, the first external electrode 31 may be formed on the first connection via 221, and the second external electrode 32 may be formed on the second connection via 222. The first external electrode 31 and the second external electrode 32 may be formed through a deposition process. Chemical vapor deposition (CVD), atomic layer deposition (ALD), sputtering, or the like may be used to form the external electrode 30. Additionally, the external electrode 30 may be formed by a plating process.

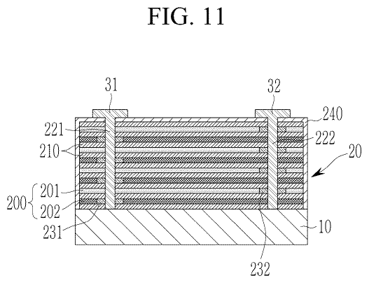

Referring to FIG. 11, the internal electrode layers IE1 and IE2, the dielectric layer DL, the insulating layer IL, and the substrate S may be cut to have a size corresponding to one capacitor 1. The cutting process may be performed through a dicing process. The dicing process may be performed using a blade, a laser, or the like. Additionally, the insulating layer 240 may be formed on outer end portions of the first internal electrode 201 and the second internal electrode 202. The insulating layer 240 may be formed through a deposition process. Accordingly, the insulating layer 240 may be disposed on an outer side surface of the body 20.

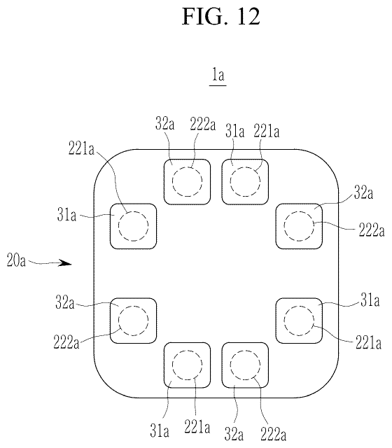

FIG. 12 is a plan view of a capacitor 1a according to a second embodiment.

Referring to FIG. 12, in the capacitor 1a according to the second embodiment, a plurality of first connection vias 221a and a plurality of second connection vias 222a may be disposed at a body 20a.

The first connection via 221a may be provided in a plural number. Three or more first connection via 221a may be provided. FIG. 12 illustrates a case in which four first connection vias 221a are provided. The first connection vias 221a may be disposed to be spaced apart from each other. Two first connection vias 221a may be disposed to be spaced apart from each other in the length direction L of the body 20a. The two first connection vias 221a may be disposed to be spaced apart from each other in the width direction W of the body 20a.

The second connection via 222a may be provided in a plural number. Three or more second connections via 222a may be provided. The number of second connection vias 222a may be the same as or different from the number of first connection vias 221a. FIG. 12 illustrates a case in which four second connection vias 222a are provided. The second connection vias 222a may be disposed to be spaced apart from each other. Two second connection vias 222a may be disposed to be spaced apart from each other in the length direction L of the body 20a. The two second connection vias 222a may be disposed to be spaced apart from each other in the width direction W of the body 20a.

External electrodes 31a and 32a include a first external electrode 31a and a second external electrode 32a.

The first external electrode 31a may be disposed on an upper surface of the body 20a. The first external electrode 31a may be provided in a plural number and in the same number as that of the first connection via 221a. Each of the first external electrodes 31a is disposed on the first connection via 221a and is connected to the first connection via 221a.

The second external electrode 32a may be disposed on the upper surface of the body 20a. The second external electrode 32a may be provided in a plural number and in the same number as that of the second connection via 222a. Each of the second external electrodes 32a may be disposed on the second connection via 222a and may be connected to the second connection via 222a.

In one embodiment, the first and second connection vias 221a and 222a may overlap the first and second external electrodes 31a and 32a, respectively, in the vertical direction T.

Because the remaining configuration of the capacitor 1a is the same as or similar to that of the capacitor 1 described above in FIGS. 1 and 2, a repeated description thereof is omitted.

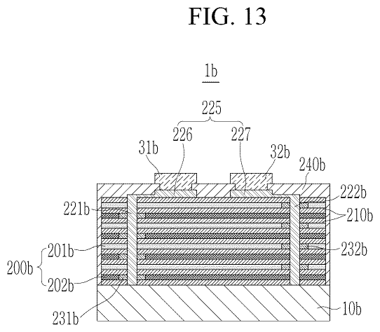

FIG. 13 is a cross-sectional view of a capacitor 1b according to a third embodiment.

Referring to FIG. 13, in the capacitor 1b according to the third embodiment, connection vias 221b and 222b and external electrodes 31b and 32b may be connected to each other by a connection layer 225. The connection layer 225 may be disposed on a dielectric layer 210b disposed at an uppermost side. The connection layer 225 may be disposed between an insulating layer 240b and the dielectric layer 210b disposed at the uppermost side. The connection layer 225 may be provided as a conductive material. The connection layer 225 may be made of a metallic material.

The connection layer 225 includes a first connection layer 226 and a second connection layer 227.

The first connection layer 226 may be disposed between a first connection via 221b and a first external electrode 31b, so that the first connection via 221b and the first external electrode 31b are electrically connected to each other. One end portion of the first connection layer 226 may be connected to an upper portion of the first connection via 221b. The other end portion of the first connection layer 226 may be connected to the first external electrode 31b. A region where the first external electrode 31b and the first connection layer 226 are connected to each other may penetrate the insulating layer 240b.

The second connection layer 227 may be disposed between a second connection via 222b and a second external electrode 32b, so that the second connection via 222b and the second external electrode 32b are electrically connected to each other. One end portion of the second connection layer 227 may be connected to an upper portion of the second connection via 222b. The other end portion of the second connection layer 227 may be connected to the second external electrode 32b. A region where the second external electrode 32b and the second connection layer 227 are connected to each other may penetrate the insulating layer 240b.

Because a substrate 10b, an internal electrode 200b including a first internal electrode 201b and a second internal electrode 202b, a first via separation layer 231b, and a second via separation layer 232b may be the same as or similar to those of the capacitor 1 described in FIG. 1 and FIG. 2, a repeated description thereof is omitted.

In addition, because the first connection via 221b and the second connection via 222b are the same as or similar to those of the capacitor 1 described in FIG. 1 and FIG. 2 or the capacitor 1a described in FIG. 12 except that the first connection via 221b and the second connection via 222b are connected to the external electrodes 31b and 32b through the connection layer 225, a repeated description thereof is omitted.

In the capacitor 1b according to the third embodiment, positions of the external electrodes 31b and 32b may be adjusted so as to be spaced apart from positions of upper portions of the connection vias 221b and 222b. Accordingly, the positions of the connection vias 221b and 222b and the external electrodes 31b and 32b may be freely adjusted to more effectively reduce the equivalent serial resistance (ESR).

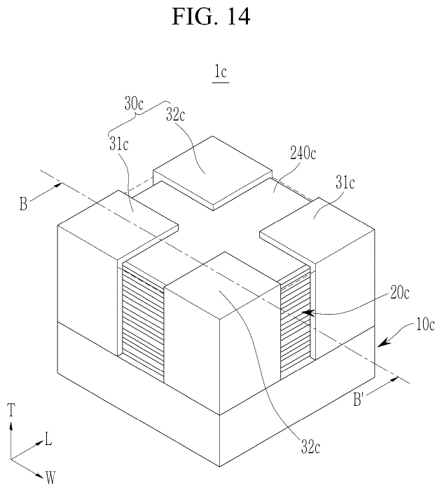

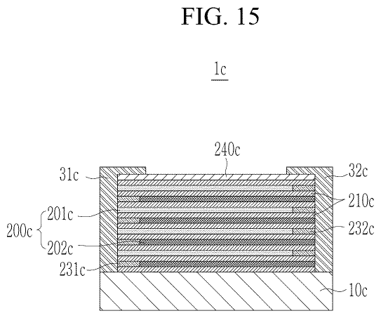

FIG. 14 is a view showing a capacitor 1c according to a fourth embodiment, and FIG. 15 is a cross-sectional view taken along a line B-B′ of FIG. 14.

Referring to FIG. 14 and FIG. 15, the capacitor 1c according to the fourth embodiment may include a substrate 10c, a body 20c, and an external electrode 30c.

The substrate 10c may have a predetermined area. The substrate 10c may be provided as an insulating material.

The body 20c may be disposed on an upper surface of the substrate 10c. The body 20c may include an internal electrode 200c and a dielectric layer 210c. The body 20c may have a predetermined length along the length direction L of the substrate 10c. The body 20c may have a predetermined width along the width direction W of the substrate 10c. The body 20c may have a predetermined thickness along the vertical direction T.

The internal electrode 200c may include a first internal electrode 201c and a second internal electrode 202c.

The first internal electrode 201c and the second internal electrode 202c may be stacked and disposed on the upper surface of the substrate 10c. The first internal electrode 201c and the second internal electrode 202c may be alternately stacked. A dielectric layer 210c may be disposed between the first internal electrode 201c and the second internal electrode 202c. The dielectric layer 210c may be disposed on the internal electrode 200c disposed at an uppermost side. Additionally, an insulating layer 240c may be disposed on the dielectric layer 210c disposed at the uppermost side.

The external electrode 30c may be connected to the internal electrode 200c at some regions of an end portion of the body 20c in the length direction L or some regions of an end portion of the body 20c in the width direction W. That is, the external electrode 30c may be disposed to cover an outer side surface of the body 20c at some regions of the end portion of the body 20c in the length direction L or some regions of the end portion of the body 20c in the width direction W. Accordingly, the internal electrode 200c exposed to the outer side surface of the body 20c may be connected to the external electrode 30c. The external electrode 30c may cover some regions of an upper surface of the body 20c.

The external electrode 30c may include a first external electrode 31c and a second external electrode 32c.

The first external electrode 31c may be disposed to cover the outer side surface of the body 20c so that it is connected to a portion of the first internal electrode 201c exposed to the outer side surface of the body 20c. The first external electrode 31c may be connected by directly contacting a portion of the first internal electrode 201c exposed to the outer side surface of the body 20c.

A first electrode separation layer 231c may be disposed between the first external electrode 31c and the second internal electrode 202c. That is, the second internal electrode 202c may have a structure that is recessed in an opposite direction of the first external electrode 31c at a region facing the first external electrode 31c. Additionally, the first electrode separation layer 231c may be disposed between end portions of the first external electrode 31c and the second internal electrode 202c. The first electrode separation layer 231c may be made of an insulating material.

The first external electrode 31c may be connected to a portion of the first internal electrode 201c exposed to the outer side surface at some regions of an end portion of the body 20c in the length direction L or some regions of an end portion of the body 20c in the width direction W. The first external electrode 31c may cover some regions of the upper surface of the body 20c.

The first external electrode 31c may be disposed at a corner region where the end portion of the body 20c in the length direction L and the end portion of the body 20c in the width direction W meet, so that it is connected to a portion of the first internal electrode 201c exposed to the outer side surface at some regions of the end portion of the body 20c in the length direction L and some regions of the end portion of the body 20c in the width direction W. The first external electrode 31c may cover some regions of the upper surface of the body 20c at the corner region where the end portion of the body 20c in the length direction L and the end portion of the body 20c in the width direction W meet.

The first external electrode 31c may be provided in a plural number. Two first external electrodes 31c may be provided. The two first external electrodes 31c may be disposed to be spaced apart from each other along the length direction L of the body 20c. Additionally, the two first external electrodes 31c may be disposed to be spaced apart from each other along the width direction W of the body 20c. Additionally, the two first external electrodes 31c may be disposed to be spaced apart from each other in a diagonal direction crossing the length direction L and the width direction W of the body 20c.

The second external electrode 32c may be disposed to cover the outer side surface of the body 20c so that it is connected to a portion of the second internal electrode 202c exposed to the outer side surface of the body 20c. The second external electrode 32c may be connected by directly contacting a portion of the second internal electrode 202c exposed to the outer side surface of the body 20c.

A second electrode separation layer 232c may be disposed between the second external electrode 32c and the first internal electrode 201c. That is, the first internal electrode 201c may have a structure that is recessed in an opposite direction of the second external electrode 32c at a region facing the second external electrode 32c. Additionally, the second electrode separation layer 232c may be disposed between end portions of the second external electrode 32c and the first internal electrode 201c. The second electrode separation layer 232c may be made of an insulating material.

The second external electrode 32c may be connected to a portion of the second internal electrode 202c exposed to the outer side surface at some regions of an end portion of the body 20c in the length direction L or some regions of an end portion of the body 20c in the width direction W. The second external electrode 32c may cover some regions of the upper surface of the body 20c.

The second external electrode 32c may be disposed at a corner region where the end portion of the body 20c in the length direction L and the end portion of the body 20c in the width direction W meet, so that it is connected to a portion of the second internal electrode 202c exposed to the outer side surface at some regions of the end portion of the body 20c in the length direction L and some regions of the end portion of the body 20c in the width direction W. The second external electrode 32c may cover some regions of the upper surface of the body 20c at the corner region where the end portion of the body 20c in the length direction L and the end portion of the body 20c in the width direction W meet.

The second external electrode 32c may be provided in a plural number. Two second external electrodes 32c may be provided. The two second external electrodes 32c may be disposed to be spaced apart from each other along the length direction L of the body 20c. Additionally, the two second external electrodes 32c may be disposed to be spaced apart from each other along the width direction W of the body 20c. Additionally, the two second external electrodes 32c may be disposed to be spaced apart from each other in a diagonal direction crossing the length direction L and the width direction W of the body 20c.

Additionally, the insulating layer 240c may be disposed on the outer side surface of the body 20c except for a region covered by the external electrode 30c.

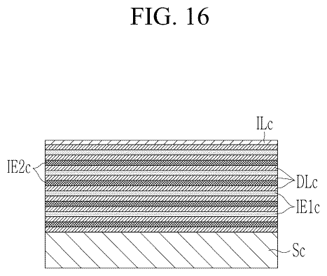

FIGS. 16 to 20 are views showing a method for manufacturing the capacitor 1c of the fourth embodiment according to an embodiment of the present disclosure.

Hereinafter, the method for manufacturing the capacitor 1c will be described with reference to FIGS. 16 to 20.

Referring to FIG. 16, internal electrode layers IE1c and IE2c and a dielectric layer DLc for forming the body 20c may be formed on a substrate Sc. Additionally, an insulating layer ILc may be formed at an uppermost portion thereof. Because a method for forming the internal electrode layers IE1c and IE2c, the dielectric layer DLc, and the insulating layer ILc is the same as or similar to the method described above in FIG. 4, a repeated description thereof is omitted.

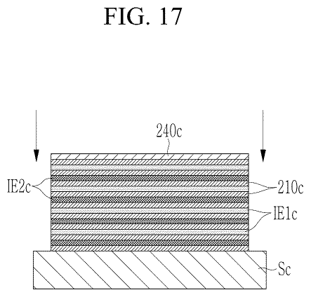

Referring to FIG. 17, the internal electrode layers IE1c and IE2c and the dielectric layer DLc may be cut to have a size corresponding to one body 20c. An etching process may be used for the cutting. The etching process may be a dry etching process using plasma. Additionally, the cutting may be performed using a laser.

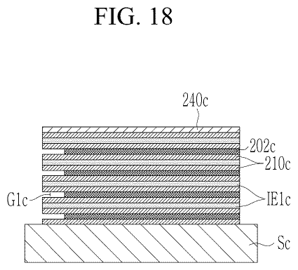

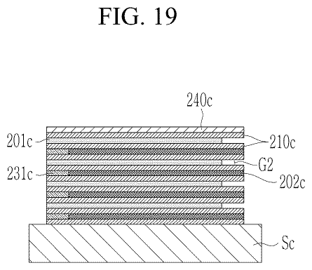

Referring to FIG. 18 and FIG. 19, the first internal electrode 201c exposed to the outside may be selectively etched to form a first separation groove G1c. The first internal electrode 201c may be formed through dry etching using a chemical or dry etching using plasma. In addition, the first separation groove

G1c may be filled with an insulating material to form the first electrode separation layer 231c.

In addition, the second internal electrode 202c exposed to the outside may be selectively etched to form a second separation groove G2c. The second internal electrode 202c may be formed through dry etching using a chemical or dry etching using plasma. In addition, the second separation groove G2c may be filled with an insulating material to form the second electrode separation layer 232c.

Although a case in which the first electrode separation layer 231c is formed first and the second electrode separation layer 232c is formed thereafter is described, the second electrode separation layer 232c may be formed first and the first electrode separation layer 231c may be formed thereafter.

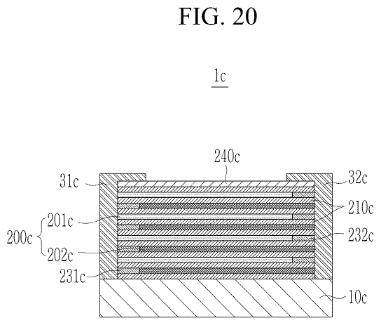

Referring to FIG. 20, the external electrode 30c may be formed to cover the outer side surface of the body 20c. Chemical vapor deposition (CVD), atomic layer deposition (ALD), sputtering, or the like may be used to form the external electrode 30c. Additionally, the external electrode 30c may be formed by a plating process. Thereafter, the substrate Sc may be cut to have a size corresponding to one capacitor 1c. The cutting process may be performed through a dicing process. The dicing process may be performed using a blade, a laser, or the like.

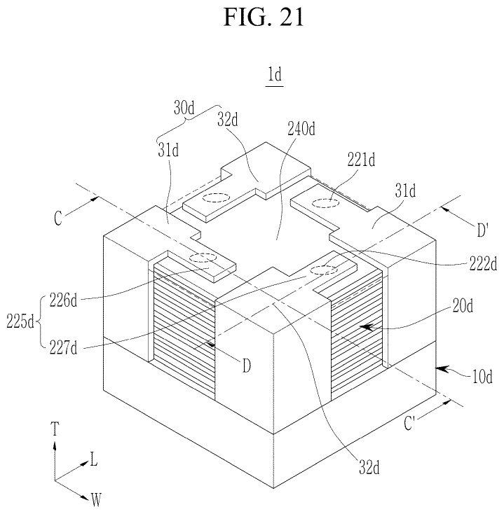

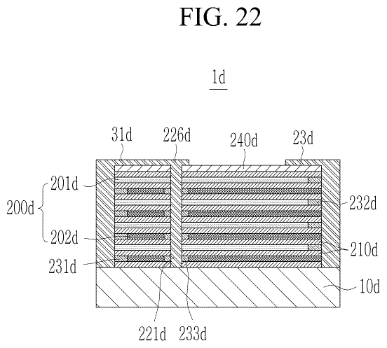

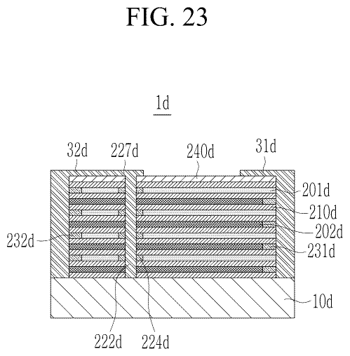

FIG. 21 is a view showing a capacitor 1d according to a fifth embodiment, FIG. 22 is a cross-sectional view taken along a line C-C′ of FIG. 21, and FIG. 23 is a cross-sectional view taken along a line D-D′ of FIG. 22.

Referring to FIGS. 21 to 23, an external electrode 30d may be connected to an internal electrode 200d at some regions of an end portion of a body 20d in the length direction L or some regions of an end portion of the body 20d in the width direction W. In other words, the external electrode 30d may be disposed to cover an outer side surface of the body 20d at some regions of the end portion of the body 20d in the length direction L or some regions of the end portion of the body 20d in the width direction W. Accordingly, a portion of the internal electrode 200d exposed to the outer side surface of the body 20d may be connected to the external electrode 30d. Additionally, the external electrode 30d may cover some regions of an upper surface of the body 20d.

The external electrode 30d may include a first external electrode 31d and a second external electrode 32d.

The first external electrode 31d may be disposed to cover the outer side surface of the body 20d so that it is connected to a portion of a first internal electrode 201d exposed to the outer side surface of the body 20d. The first external electrode 31d may be connected by directly contacting the portion of the first internal electrode 201d exposed to the outer side surface of the body 20d. A first electrode separation layer 231d may be disposed between the first external electrode 31d and a second internal electrode 202d.

Additionally, a region disposed to cover the upper surface of the body 20d at the first external electrode 31d may be connected to a first connection via 221d. Accordingly, the first external electrode 31d is connected to the first internal electrode 201d through the first connection via 221d. A first via separation layer 233d may be disposed between the first connection via 221d and the second internal electrode 202d.

The second external electrode 32d may be disposed to cover the outer side surface of the body 20d so that it is connected to a portion of the second internal electrode 202d exposed to the outer side surface of the body 20d. The second external electrode 32d may be connected by directly contacting the portion of the second internal electrode 202d exposed to the outer side surface of the body 20d. A second electrode separation layer 232d may be disposed between the second external electrode 32d and the first internal electrode 201d.

Additionally, a region disposed to cover the upper surface of the body 20d at the second external electrode 32d may be connected to a second connection via 222d. Accordingly, the second external electrode 32d is connected to the second internal electrode 202d through the second connection via 222d. A second via separation layer 224d may be disposed between the second connection via 222d and the first internal electrode 201d.

Because a structure in which the external electrode 30d is connected to the internal electrode 200d at the outer side surface of the body 20d is the same as or similar to that of the capacitor 1c described in FIG. 14 and FIG. 15, a repeated description thereof is omitted.

In addition, because a structure in which the external electrode 30d is connected to the internal electrode 200d through the connection vias 221d and 222d is the same as or similar to that of the capacitor 1 described in FIG. 1 and FIG. 2, the capacitor 1a described in FIG. 12, or the capacitor 1b described in FIG. 13, a repeated description thereof is omitted.

According to the capacitor 1d according to the fifth embodiment, a current path may be formed in various paths between the external electrode 30d and an internal electrode 225d. Accordingly, the equivalent serial resistance (ESR) may be effectively reduced by adjusting the current path.

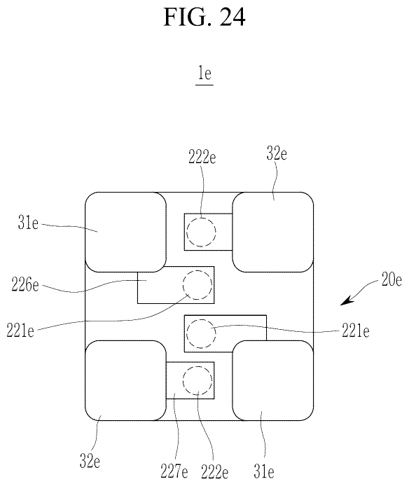

FIG. 24 is a plan view of a capacitor 1e according to a sixth embodiment.

Referring to FIG. 24, in the capacitor 1e according to the sixth embodiment, a plurality of first connection vias 221e and a plurality of second connection vias 222e may be disposed at a body 20e.

The first connection via 221e and the second connection via 222e may be disposed at a central region of the length direction L of the body 20e or the width direction W of the body 20e. Additionally, the first connection via 221eand the second connection via 222e may be alternately disposed and spaced apart from each other along the width direction W of the body 20e or the length direction L of the body 20e. Two first connections via 221e may be provided. Two second connections via 222e may be provided.

External electrodes 31e and 32e may include a first external electrode 31e and a second external electrode 32e.

The first external electrode 31e may be disposed on an upper surface of the body 20e. Like the first connection via 221e, two first external electrodes 31e may be provided. The two first external electrodes 31e may be disposed to be spaced apart from each other along the length direction L of the body 20e. Additionally, the two first external electrodes 31e may be disposed to be spaced apart from each other along the width direction W of the body 20e. Accordingly, the two first external electrodes 31e may be disposed to be spaced apart from each other in a diagonal direction crossing the length direction L and the width direction W of the body 20e. The first external electrode 31e may be disposed adjacent to a corner where an end portion of the body 20e in the length direction L and an end portion of the body 20e in the width direction W meet.

The second external electrode 32e may be disposed on the upper surface of the body 20e. Like the second connection via 222e, two second external electrodes 32e may be provided. The two second external electrodes 32e may be disposed to be spaced apart from each other along the length direction L of the body 20e. Additionally, the two second external electrodes 32e may be disposed to be spaced apart from each other along the width direction W of the body 20e. Accordingly, the two second external electrodes 32e may be disposed to be spaced apart from each other in a diagonal direction crossing the length direction L and the width direction W of the body 20e. The second external electrode 32e may be disposed adjacent to a corner where an end portion of the body 20e in the length direction L and an end portion of the body 20e in the width direction W meet.

The connection vias 221e and 222e and the external electrodes 31e and 32e may be connected to each other by connection layers 226e and 227e. The connection layers 226e and 227e may be provided as a conductive material. The connection layers 226e and 227e may be made of a metallic material. The connection layers 226e and 227e may include a first connection layer 226e and a second connection layer 227e.

The first connection layer 226e may be disposed between the first connection via 221e and the first external electrode 31e, so that the first connection via 221e and the first external electrode 31e are electrically connected to each other.

The second connection layer 227e may be disposed between the second connection via 222e and the second external electrode 32e, so that the second connection via 222e and the second external electrode 32e are electrically connected to each other.

Additionally, the first external electrode 31e may be disposed to cover an outer side surface of the body 20e, so that it is connected to the first internal electrode on the outer side surface of the body 20e.

Additionally, the second external electrode 32e may be disposed to cover the outer side surface of the body 20e, so that it is connected to the second internal electrode on the outer side surface of the body 20e.

Because a structure in which the external electrodes 31e and 32e and the connection vias 221e and 222e are connected by the connection layers 226e and 227e is the same as or similar to that of the capacitor 1b described above in FIG. 13, a repeated description thereof is omitted.

Because a structure in which the external electrodes 31e and 32e and the internal electrode are connected to a side surface of the body 20e is the same as or similar to that of the capacitor 1c described above in FIG. 14 and FIG. 15, a repeated description thereof is omitted.

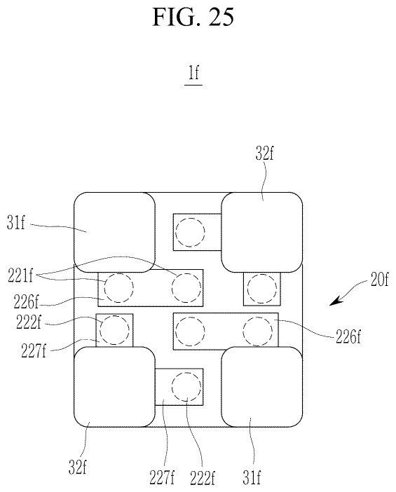

FIG. 25 is a plan view of a capacitor 1f according to a seventh embodiment.

Referring to FIG. 25, external electrodes 31f and 32f of the capacitor 1faccording to the seventh embodiment may include the first external electrode 31f and the second external electrode 32f.

The first external electrode 31f may be disposed on an upper surface of a body 20f. Two first external electrodes 31f may be provided. The two first external electrodes 31f may be disposed to be spaced apart from each other along the length direction L of the body 20f. Additionally, the two first external electrodes 31f may be disposed to be spaced apart from each other along the width direction W of the body 20f. Accordingly, the two first external electrodes 31f may be disposed to be spaced apart from each other in a diagonal direction crossing the length direction L and the width direction W of the body 20f. The first external electrode 31f may be disposed adjacent to a corner where an end portion of the body 20f in the length direction L and an end portion of the body 20f in the width direction W meet.

The second external electrode 32f may be disposed on an upper surface of the body 20f. Two second external electrodes 32f may be provided. The two second external electrodes 32f may be disposed to be spaced apart from each other along the length direction L of the body 20f. Additionally, the two second external electrodes 32f may be disposed to be spaced apart from each other along the width direction W of the body 20f. Accordingly, the two second external electrodes 32f may be disposed to be spaced apart from each other in a diagonal direction crossing the length direction L and the width direction W of the body 20f. The second external electrode 32f may be disposed adjacent to a corner where an end portion of the body 20f in the length direction L and an end portion of the body 20f in the width direction W meet.

In the capacitor 1f, a plurality of first connection vias 221f and a plurality of second connection vias 222f may be disposed at the body 20f. The number of the first connection via 221f may be greater than that of the first external electrode 31f. The number of the second connection via 222f may be greater than that of the second external electrode 32f.

As an example, portions of the first connection via 221f and the second connection via 222f may be disposed at a central region of the body 20f in the length direction L or in the width direction W. Additionally, the first connection via 221f and the second connection via 222f may be alternately disposed and spaced apart from each other along the width direction W of the body 20f or the length direction L of the body 20f. Additionally, the remaining portion of the first connection via 221f may be disposed at a region between the first external electrode 31f and the second external electrode 32f. Additionally, the remaining portion of the second connection via 222f may be disposed at a region between the first external electrode 31f and the second external electrode 32f.

The connection vias 221f and 222f and the external electrodes 31f and 32f may be connected to each other by connection layers 226f and 227f. The connection layers 226f and 227f may be provided as a conductive material. The connection layers 226f and 227f may be made of a metallic material. The connection layers 226f and 227f include the first connection layer 226f and the second connection layer 227f.

The first connection layer 226f may be disposed between the first connection via 221f and the first external electrode 31f, so that the first connection via 221f and the first external electrode 31f are electrically connected to each other. Accordingly, the first external electrode 31f may be connected to two or more first connection vias 221f.

The second connection layer 227f may be disposed between the second connection via 222f and the second external electrode 32f, so that the second connection via 222f and the second external electrode 32f are electrically connected to each other. Accordingly, the second external electrode 32f may be connected to two or more second connection vias 222f.

Additionally, the first external electrode 31f may be disposed to cover an outer side surface of the body 20f, so that it is connected to the first internal electrode on the outer side surface of the body 20f.

Additionally, the second external electrode 32f may be disposed to cover the outer side surface of the body 20f, so that it is connected to the second internal electrode on the outer side surface of the body 20f.

Because a structure in which the external electrodes 31f and 32f and the connection vias 221f and 222f are connected by the connection layers 226f and 227f is the same as or similar to that of the capacitor 1b described above in FIG. 13, a repeated description thereof is omitted.

Because a structure in which the external electrodes 31f and 32f and the internal electrode are connected to a side surface of the body 20f is the same as or similar to that of the capacitor 1c described above in FIG. 14 and FIG. 15, a repeated description thereof is omitted.

While the embodiment of the present disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: substrate
20: body
30: external electrode
31: first external electrode
32: second external electrode
200: internal electrode
201: first internal electrode
202: second internal electrode
210: dielectric layer
221: first connection via
222: second connection via
231: first via separation layer
232: second via separation layer

What is claimed is:

1. A capacitor comprising:
a body that includes a first internal electrode and a second internal electrode stacked with a dielectric layer interposed therebetween;
a first external electrode that is disposed to cover an upper surface of the body and an outer side surface of the body and is connected to the first internal electrode through the upper surface of the body and the outer side surface of the body; and
a second external electrode that is disposed to cover the upper surface of the body and the outer side surface of the body and is connected to the second internal electrode through the upper surface of the body and the outer side surface of the body.

2. The capacitor of claim 1, further comprising:
a first connection via disposed inside the body to connect the first internal electrode and the first external electrode; and
a second connection via disposed inside the body to connect the second internal electrode and the second external electrode.

3. The capacitor of claim 2, further comprising a first via separation layer disposed between the first connection via and the second internal electrode.

4. The capacitor of claim 2, further comprising a second via separation layer disposed between the second connection via and the first internal electrode.

5. The capacitor of claim 2, wherein the first external electrode contacts the first connection via, and the second external electrode contacts the second connection via.

6. The capacitor of claim 2, further comprising:
a first connection layer connecting the first external electrode and the first connection via; and
a second connection layer connecting the second external electrode and the second connection via.

7. The capacitor of claim 6, wherein the first connection layer and the second connection layer are disposed on an uppermost dielectric layer among dielectric layers including the uppermost dielectric layer.

8. The capacitor of claim 6, wherein the number of first connection vias including the first connection via is greater than or equal to the number of first external electrodes including the first external electrode.

9. The capacitor of claim 6, wherein the number of second connection vias including the second connection via is greater than or equal to the number of second external electrodes including the second external electrode.

10. The capacitor of claim 1, wherein each of the first external electrode and the second external electrode is disposed adjacent to a corner where an end portion of the body in a length direction and an end portion of the body in a width direction meet.

11. The capacitor of claim 1, wherein each of the first external electrode and the second external electrode is provided in two.

12. The capacitor of claim 1, wherein the first external electrode is connected to a portion of the first internal electrode exposed to the outer side surface of the body, and the second external electrode is connected to a portion of the second internal electrode exposed to the outer side surface of the body.

13. The capacitor of claim 12, further comprising:
a first electrode separation layer disposed between the first external electrode and the second internal electrode; and
a second electrode separation layer disposed between the second external electrode and the first internal electrode.

14. A capacitor comprising:
a substrate;
a body that includes a first internal electrode and a second internal electrode stacked with a dielectric layer interposed therebetween and is disposed on the substrate;
a first external electrode that is disposed to cover an upper surface of the body and an outer side surface of the body and is connected to the first internal electrode; and
a second external electrode that is disposed to cover the upper surface of the body and the outer side surface of the body and is connected to the second internal electrode.

15. The capacitor of claim 14, wherein the first external electrode is connected to a portion of the first internal electrode exposed to the outer side surface of the body, and the second external electrode is connected to a portion of the second internal electrode exposed to the outer side surface of the body.

16. The capacitor of claim 14, wherein each of the first external electrode and the second external electrode is disposed adjacent to a corner where an end portion of the body in a length direction and an end portion of the body in a width direction meet.

17. The capacitor of claim 16, wherein each of the first external electrode and the second external electrode is provided in two.

18. A capacitor comprising:
a substrate;
a body that includes a first internal electrode and a second internal electrode stacked with a dielectric layer interposed therebetween and is disposed on an upper surface of the substrate;
two first external electrodes that are disposed to be spaced apart from each other on an upper surface of the body and are connected to the first internal electrode; and
two second external electrodes that are disposed to be spaced apart from each other on the upper surface of the body and are connected to the second internal electrode.

19. The capacitor of claim 18, further comprising:
a first connection via disposed inside the body and connected to the first internal electrode; and
a second connection via disposed inside the body and connected to the second internal electrode.

20. The capacitor of claim 18, wherein a portion of the first external electrodes covers an outer side surface of the body and is connected to a portion of the first internal electrode exposed to the outer side surface of the body, and a portion of the second external electrodes covers the outer side surface of the body and is connected to a portion of the second internal electrode exposed to the outer side surface of the body.
